(19) United States
(12) Patent Application Publication
(10) Pub. No.: US 2006/0082276 A1
(43) Pub. Date: Apr. 20, 2006

(54) Ignition device having noble metal fine wire electrodes

(76) Inventors: Karina C. Havard, Toledo, OH (US); Robert Freeman, Monclova, OH (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/964,958

(22) Filed: Oct. 14, 2004

(51) Int. Cl. H01T 13/20

(52) U.S. Cl. 313/141

(57) ABSTRACT

An ignition device for an internal combustion engine, such as a spark plug, includes two fine wire, rectangular cross-section, noble metal ground electrodes and a center electrode having a fine wire, rectangular cross-section, noble metal firing tip. The ignition device includes a metal housing and an insulator secured within the metal housing which has an exposed electrode end at an opening in the housing. The insulator houses a center electrode having an electrode base mounted in the insulator and extending through the insulator at the electrode end. The electrode base has an axial bore in an end proximate the electrode end of the insulator. The noble metal firing tip is located partly within the axial bore and is metallurgically bonded to the electrode base. The first noble metal ground electrode has a rectangular cross-section and is metallurgical bonded to the metal housing and extends inwardly to a first firing end and a first firing end face that is adjacent to a side face of the noble metal firing tip. The second noble metal ground electrode is spaced apart from the first noble metal electrode. It also has a rectangular cross-section and is metallurgically bonded to the metal housing and extends inwardly to a second firing end and a second firing end face that is adjacent to another side face of the noble metal firing tip. The noble metal firing tip and the ground electrodes are preferably formed from Ir or an Ir alloy. It is also preferred that the Ir alloy includes at least one of W, Y, La, Ru and Zr as an alloying constituent.

### BACKGROUND OF THE INVENTION

1. Technical Field

This invention relates generally to spark plugs and other ignition devices used in internal combustion engines. More particularly, this invention relates to spark plugs and other ignition devices having noble metal fine wire electrodes, such as electrodes of iridium and iridium alloys.

2. Related Art

As used herein, the term “ignition device” shall be understood to include spark plugs, igniters, and other such spark discharge devices that are used to initiate the combustion of a combustible source, such as a fuel/air mixture. Within the field of ignition devices, there exists a continuing need to improve the corrosion and erosion resistance and reduce the sparking voltage at the spark plug's center and ground electrode, or in the case of multi-electrode designs, the ground electrodes. This is due in part to a desire to operate at increased ignition device operating temperatures associated with lean burn engines and associated fuel/air mixtures, as well as to changes precipitated by the utilization of new fuel formulations. To this end, various designs have been proposed using noble metal electrodes or, more commonly, noble metal firing tips or electrodes applied to standard metal electrodes. Typically, the firing tip is formed as a pad or rivet or wire which is then welded onto the end of the electrode.

Various noble metals have been utilized in a number of spark plug firing tip and electrode configurations, including Ag, Au, Pt, Pd, Rh and Ir and their alloys. Of these noble metals and their alloys, iridium and particularly iridium alloys are of particular interest for use as noble metal firing tips or electrodes because of their superior corrosion and erosion resistance, as well as their superior sparking performance. See, for example, U.S. Pat. No. 4,540,910 to Kondo et al. which discloses a center electrode firing tip made from 70 to 90 wt % platinum and 30 to 10 wt % iridium. As mentioned in that patent, platinum-tungsten alloys have also been used for these firing tips, including platinum-iridium-tungsten alloys.

In addition to these noble metal alloys, oxide dispersion strengthened alloys have also been proposed which utilize combinations of the above-noted metals with varying amounts of different rare earth metal oxides. See, for example, U.S. Pat. No. 4,081,710 to Heywood et al. In this regard, several specific Pt-based and Ir-based alloys have been suggested which utilize yttrium oxide (Y₂O₃). In particular, U.S. Pat. No. 5,456,624 to Moore et al. discloses a firing tip made from a Pt alloy containing <2% yttrium oxide. U.S. Pat. No. 5,990,602 to Katoh et al. discloses a Pt—Ir alloy containing between 0.01 and 2% yttrium oxide. U.S. Pat. No. 5,461,275 to Oshima discloses an iridium alloy that includes between 5 and 15% yttrium oxide. While the yttrium oxide has historically been included in small amounts (e.g., <2%) to improve the strength and/or stability of the resultant alloy, the Oshima patent teaches that, by using yttrium oxide with iridium at >5% by volume, the sparking voltage can be reduced.

Further, as disclosed in U.S. Pat. No. 6,412,465 B1 to Lykowski et al. it has been determined that reduced erosion and lowered sparking voltages can be achieved at much lower percentages of yttrium oxide than are disclosed in the Oshima patent by incorporating the yttrium oxide into an alloy of tungsten and platinum. The Lykowski patent teaches an ignition device having both a ground and center electrode, wherein at least one of the electrodes includes a firing tip formed from an alloy containing platinum, tungsten, and yttrium oxide. Preferably, the alloy is formed from a combination of 91.7%-97.99% platinum, 2%-8% tungsten, and 0.01%-0.3% yttrium, by weight, and in an even more preferred construction, 95.68%-96.12% platinum, 3.8%-4.2% tungsten, and 0.08%-0.12% yttrium. The firing tip can take the form of a pad, rivet, ball, wire, or other shape and can be welded in place on the electrode.

While these and various other noble metal systems typically provide acceptable spark plug performance, particularly with respect to controlling the spark performance and providing spark erosion protection, current spark plugs which utilize noble metal tips have well-known performance limitations associated with the methods which are used to attach the noble metals components, particularly various forms of welding. In particular cyclic thermal and stresses in the operating environments associated with the use of the spark plugs, such as those resulting from the mismatch in thermal expansion coefficients between the noble metals and noble metal alloys mentioned above which are used for the electrode tips and the Ni, Ni alloy and other well-known metals which are used for the electrodes, are known to result in cracking, thermal fatigue and various other interaction phenomena that can result in the failure of the welds, and ultimately of the spark plugs themselves.

One proposed solution to address these problems is set forth in U.S. Pat. No. 6,307,307 B1 to Kanao. In this approach, an Ir alloy element is laser welded to a base element made of a Ni or Fe-based alloy, which is in turn attached to the spark plug housing. While this approach moves the attachment interface of the Ir alloy element away from the high temperature region associated with the generation of the spark, it also necessitates the incorporation of another set of attachment interfaces (i.e., between the Ir alloy element/base element and the base element/housing). Disadvantageously, these additional interfaces require additional materials and manufacturing steps and hence, additional manufacturing costs. Further, they represent additional potential points of failure due to the possibility of latent manufacturing defects and thermal fatigue processes associated with the operation of the spark plug. This patent also notes that for a noble metal alloy element formed from an alloy of more than 50% Ir that resistance welding is not applicable to secure sufficient bonding strength to the base element, and that laser welding is preferred.

Therefore, it is highly desirable to develop spark plugs having noble metal electrodes which have improved structures, so as to improve spark plug corrosion and erosion and performance and electrode reliability by alleviating or eliminating potential failure mechanisms associated with related art devices. It is also highly desirable to develop methods of making spark plugs which will achieve these performance and reliability improvements, as well as enabling the use of low cost methods of attachment of Ir or other noble metal electrodes, such as resistance welding.

### SUMMARY OF THE INVENTION

The present invention is an ignition device for an internal combustion engine, such as a spark plug, which includes two fine wire, rectangular cross-section, noble metal ground electrodes and a center electrode having a fine wire, rectangular cross-section, noble metal firing tip. The fine wire electrodes and firing tip may be formed from Ir and Ir alloys to provide protection from erosion and corrosion of the electrodes and firing tip during the operation of the device. The Ir alloys may also include at least one of W, Y, La, Ru and Zr as an alloying constituent for further improvement of erosion and corrosion resistance of the electrodes and firing tip during operation of the device.

The rectangular cross-sectional shape of the electrodes and the firing tip provides improved control of the spark gap region during the manufacture and subsequent operation of the device, particularly in combination with the improvements in erosion and corrosion behavior of these elements provided by the use of noble metals for their construction, and even more particularly when Ir and Ir alloys are used for these elements. This is particularly the case as compared to using a cylindrical center electrode and firing tip.

It is also an advantage of the invention to utilize welding processes to form a metallurgical bond between the noble metal electrodes and the metal housing and the center electrode base and the noble metal firing tip, and particularly advantageous to use of welding processes to weld the electrodes and firing tip when Ir and Ir alloys are employed for these elements. It is further particularly advantageous to employ resistance welding to metallurgically bond the electrodes to the metal housing, rather than to an intermediate structure such as a base member made from non-noble materials normally employed to form a ground electrode.

The present invention also advantageously may incorporate improved flashover protection with the other advantages described herein by lengthening the insulator portion which extends between the terminal and the metal housing portion.

### BRIEF DESCRIPTION OF THE DRAWINGS

These and other features and advantages of the present invention will become more readily appreciated when considered in connection with the following detailed description and appended drawings, wherein:

FIG. 1 is a front elevation view of an ignition device of the present invention;

FIG. 2 is bottom view of the ignition device of FIG. 1;

FIG. 3 is cross-sectional view of the ignition device of FIG. 2 along line 3-3;

FIG. 4 is an enlargement of region 4 of FIG. 2;

FIG. 5 is a partial cross-sectional view of the ignition device of FIG. 4 along line 5-5;

FIG. 6 is a partial cross-sectional view of the ignition device of FIG. 4 along line 6-6;

FIG. 7 is a partial cross-sectional view of the insulator and metal housing illustrating the assembly of the insulator and center electrode and metal housing and ground electrodes;

FIGS. 8A-8D are partial cross-sectional views illustrating one embodiment of a method of assembling the firing tip of the center electrode;

FIGS. 9A-9C are partial cross-sectional views illustrating one embodiment of a method of assembling a ground electrode;

FIG. 10 is a photograph of one embodiment of a noble metal firing tip and noble metal ground electrodes of an ignition device of the present invention;

FIG. 11 is an optical photomicrograph of a section of a noble metal center electrode of an ignition device of the present invention; and

FIG. 12 is an optical photomicrograph of a section of a noble metal center electrode of an ignition device of the present invention.

In the figures the same reference numerals are utilized throughout with regard to common elements.

### DETAILED DESCRIPTION OF THE PREFERRED EMBODIMENT

The present invention is a spark ignition device 10 such as a spark plug 12. Spark plug 12 has a rectangular noble metal fine wire electrode configuration which provides improved definition and control of the spark gap regions with respect to both the manufacture and operation of the device, as further described herein. This noble metal fine wire electrode configuration is particularly well suited to industrial and other internal combustion engine applications where high reliability with respect to production of the required spark is required.

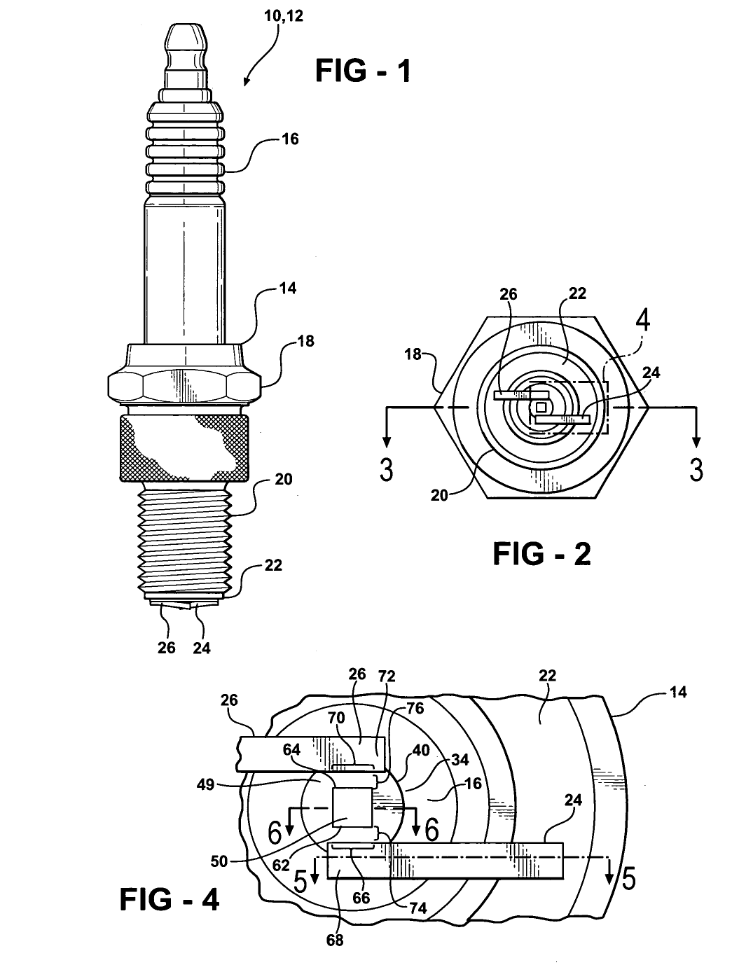

FIGS. 1-3 illustrate a spark ignition device 10 of the present invention. Ignition device 10 is preferably a spark plug 12 for an internal combustion engine. Spark plug 12 includes a metal casing or housing 14 and an insulator 16 which is secured within the metal housing 14 using conventional means and methods.

Metal housing 14 may be constructed in a conventional configuration and may include a hex-shaped attachment portion 18, standard threads 20 and an annular lower end 22 to which first noble metal ground electrode 24 and second noble metal ground electrode 26 are attached by metallurgical bonds 28,30, respectively. Metal housing 14 may be formed of any metal which is compatible with the application and operational environment of spark plug 12.

Referring to FIGS. 4 and 5, first and second noble metal electrodes 24,26 both have rectangular cross-sectional shapes. It is preferred that these cross-sectional shapes be identical. Also, in a preferred embodiment, the rectangular cross-sectional shapes are square cross-sectional shapes. It is also preferred that first and second noble metal electrodes 24,26 be made from the same noble metal. First and second noble metal electrodes 24, 26 may be made from pure iridium, platinum, palladium, rhodium, gold, silver and osmium, as well as alloys of these metals. In a preferred embodiment, first and second noble metal electrodes 24, 26 are made from pure iridium, or even more preferably, an iridium alloy. First and second noble metal electrodes 24, 26 may also include one or more of tungsten, yttrium, lanthanum, ruthenium and zirconium as an alloying addition. Metallurgical bonds 28,30 may be formed by any suitable method of forming a metallurgical bond between first and second noble metal electrodes 24,26 and metal housing 14, including various forms of welding, such as resistance welding and laser welding. It is preferred to form metallurgical bonds 28,30 using resistance welding. When employing resistance welding of pure iridium or iridium alloys, it is preferred that metal housing 14 be formed from steel. When resistance welding pure iridium or iridium alloys, the steels utilized may include low carbon steels.

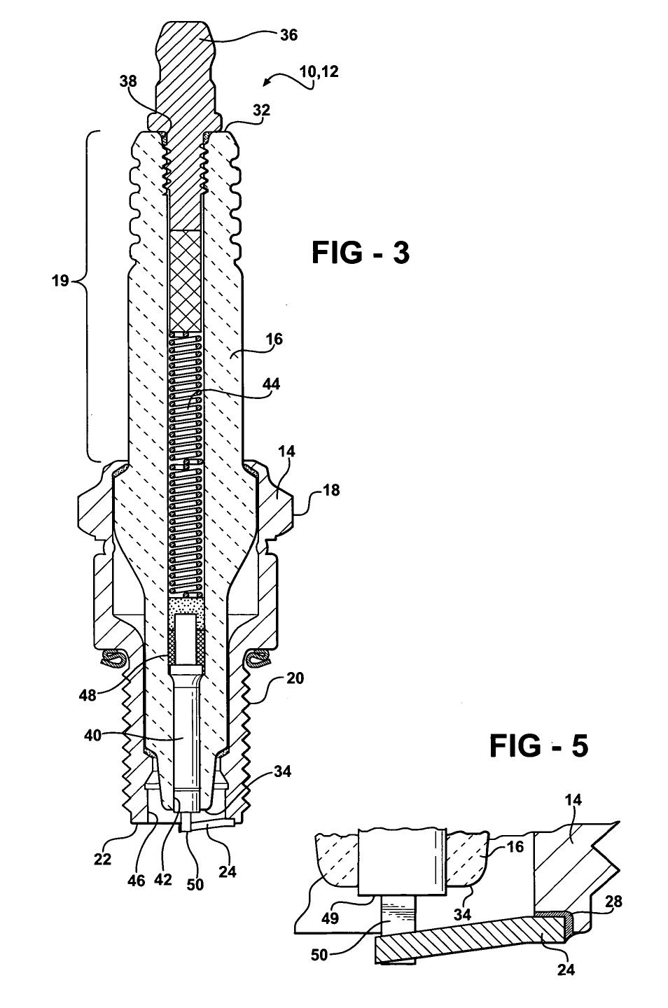

Referring to FIG. 3, insulator 16 has a terminal end 32 and an electrode end 34. Insulator 16 houses a metal terminal 36 in opening 38 in terminal end 32 and a center metal electrode 40 in opening 42 in electrode end 34. Insulator 16 also houses a resistive portion 44 which extends between and is electrically connected to metal terminal 36 and center metal electrode 40 (which is not shown in section as are other portions of FIG. 3). Resistive portion 44 and the electrical connections to metal terminal 36 and center metal electrode are of conventional construction.

As is known, the annular end 22 of metal housing 14 defines an opening 46 through which insulator 6 protrudes. Center metal electrode 40 is permanently mounted within opening 42 of insulator 14 by a glass seal 48 as illustrated or using any other suitable means for mounting electrode 40 within insulator so as to form a gas tight seal. Center metal electrode 40 extends out of insulator 14 at electrode end 34 by means of a free end 49 of electrode base 52 noble metal firing tip 50.

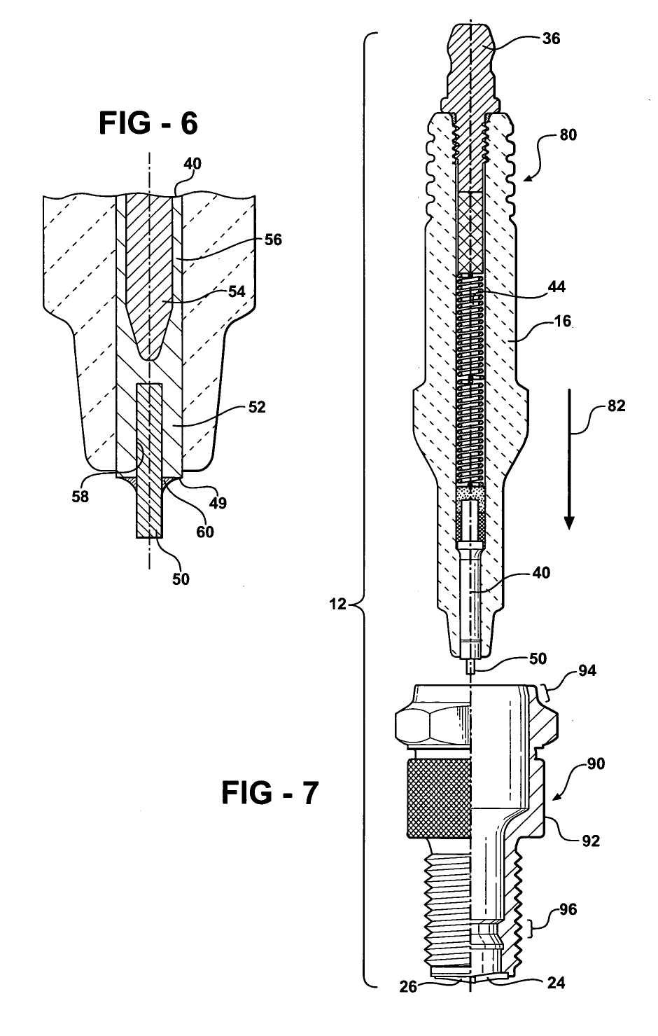

Referring to FIG. 6, center metal electrode 40 has electrode base 52. Electrode base 52 is preferably formed from a metal that has good high temperature oxidation and corrosion resistance and which also has good thermal conductivity for removing heat from the firing tip during operation of the spark plug. It is preferred that metal base 52 has a core 54 formed from a Cu alloy (which includes pure Cu) and an outer cladding or shell 56 formed from a Ni alloy (which includes pure Ni). The Cu alloy provides good thermal conductivity and the Ni alloy provides good oxidation and corrosion resistance. Center metal electrode 40 has an axial bore 58. Noble metal firing tip 50 is located within axial bore 58 and attached to metal base 52 by metallurgical bond 60 between them. Noble metal firing tip 50 preferably has a rectangular cross-sectional shape and extends axially and downwardly along longitudinal axis 52 from insulator 14. Noble metal firing tip 50 may be made from pure iridium, platinum, palladium, rhodium, gold, silver and osmium, as well as alloys of these metals. In a preferred embodiment, noble metal firing tip 50 is made from pure iridium, or even more preferably, an iridium alloy. Noble metal firing tip 50 may also include one or more of tungsten, yttrium, lanthanum, ruthenium and zirconium as an alloying addition. Further, noble metal firing tip 50 and first and second noble metal electrodes 24, 26 may each be formed from the same noble metal alloy or different noble metal alloys.

Firing tip 50 has a first side face 62 and a second side face 64. In the embodiment illustrated in FIGS. 1-4, first side face 62 is located so that it is adjacent to the first firing end face 66 of the first firing end 68 of first noble metal ground electrode 24. Second side face 64 is located so that it is adjacent to the second firing end face 70 of the second firing end 72 of second noble metal ground electrode 26. The space between first side face 62 and first firing end face 66 defines a first spark gap 74. The space between second side face 64 and second firing end face 70 defines a second spark gap 76. Preferably, first side face 62 and first firing end face 66 are substantially parallel to one another, such that the separation distance of the spark gap between them is constant. Preferably, second side face 64 and second firing end face 70 are substantially parallel to one another, such that the separation distance of the second spark gap between them is also constant. Further, it is preferred that the first spark gap 74 distance and second spark gap 76 distance is the same.

Insulator 16 also may also be constructed so as to improve the resistance of spark plug 12 to a well-known phenomenon known as flashover. Flashover occurs when a conductive path exists on the exterior of spark plug that has a resistance that is lower than the resistance of resistive portion 44. This can occur for a number of reasons, including elevated spark plug temperature, increased ambient humidity and the accumulation of dirt, carbon or other impurities on the exterior surface of spark plug 12. When this occurs, the intended spark current is discharged over the exterior surface of spark plug 12 rather than across the first or second spark plug gaps resulting in a failure to ignite the fuel/air mixture, and a resultant loss in engine power and fuel economy. In order to improve the resistance to flashover, it is preferred to lengthen the upper portion 19 (see FIG. 3) of insulator 16 between the terminal end and the uppermost portion of metal housing 14. It is preferred that the length of this portion 19 of insulator 16 be greater than 1.0 inches in order to improve the resistance of sparkplug 12 to flashover.

Referring now to FIG. 7, spark plug 12 may be assembled by inserting an insulator assembly 80, including insulator 16, metal terminal 36, resistive portion 44 and center metal electrode 40 with noble metal firing tip 50, into metal housing assembly 90, including metal housing precursor 92 and attached first and second noble metal electrodes 24,26, in the direction shown by arrow 82. Once the insulators assembly 80 has been inserted into metal housing assembly 90, metal housing precursor 92 is fixed to insulator assembly by one of several known methods, such as heating them both while plastically deforming areas of metal housing precursor 92 to form metal housing 14, such as neck area 94 and belt area 96, while at the same time fixing insulator assembly 80 within metal housing 14. The assembled spark plug 12 is illustrated in FIG. 3. This assembly process also involves axially orienting the insulator assembly 80 and the metal housing precursor 92 prior to fixing them together in order to position noble metal firing tip 50 between first and second noble metal electrodes 24,26 in the spaced relationship described herein, as well as radially orienting insulator assembly 80 and the metal housing precursor 92 to orient first and second side faces 62, 64 of center electrode 48 and first and second firing end faces 66, 70 of ground electrodes 24,26 in the spaced relationships described hereinabove.

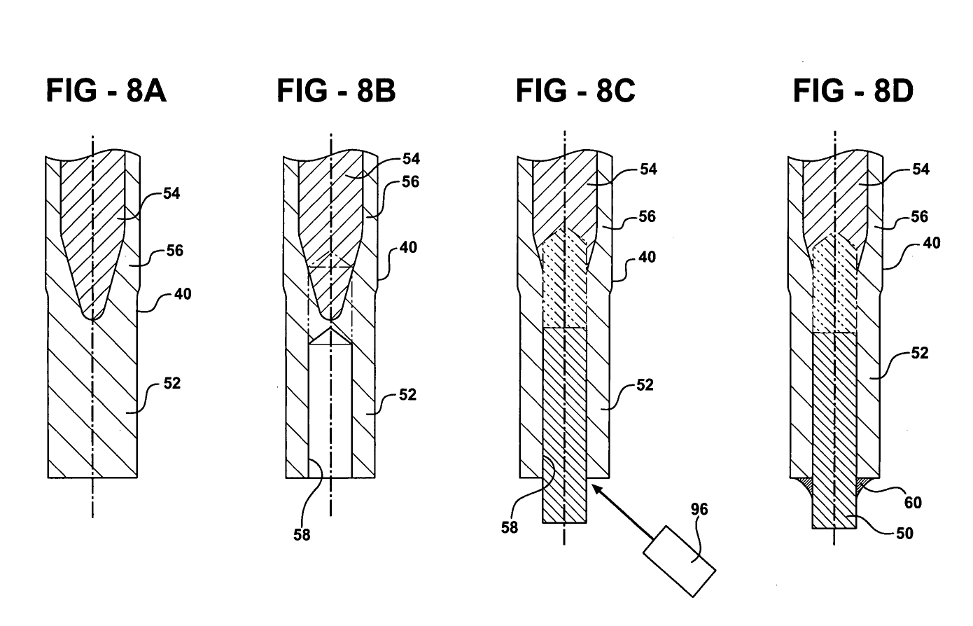

FIGS. 8A-8D illustrate a method of making the center metal electrode 40 of the invention. FIG. 8A illustrates a step of fabricating a clad metal electrode base 52 of conventional construction having a Cu alloy core 54 (preferably pure Cu) and a Ni alloy shell 56. This step may be performed using conventional methods for fabricating base 52. FIG. 8B illustrates a step of forming axial bore 58 within a free end 94 of base 52. Axial bore 58 may be formed by drilling or other conventional methods of forming a bore. Axial bore 58 may formed entirely within shell 56 as shown by the solid line section of bore 58 in FIG. 8B. Alternately and preferably axial bore 58 may extend through shell 56 into core 54, as shown by the phantom section of bore 58. FIG. 8C illustrates the insertion of noble metal firing tip 50 into axial bore 58. Axial bore 58 will be of a size and shape that is sufficient to receive the noble metal firing tip. Preferably, axial bore 58 will be cylindrical in shape and large enough in diameter to receive noble metal firing tip 50. While the portion of noble metal firing tip 50 which extends from the bore, and particularly the portion lying between first and second noble metal electrodes 24,26 is rectangular in cross-section, the portion which lies within axial bore 58 may have a different cross-section, such as a circular cross-section. FIG. 8C also illustrates the forming of metallurgical bond 60 between them by laser welding, as illustrated schematically by laser apparatus 96. FIG. 8D illustrates a completely fabricated center metal electrode 40, including noble metal firing tip 50.

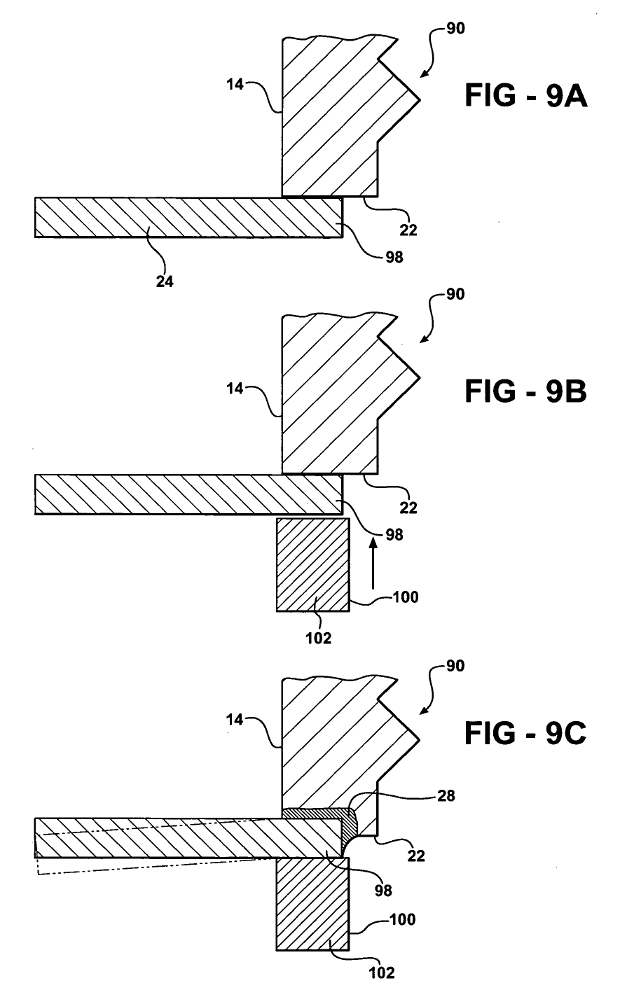

FIGS. 9A-9C illustrate a method of fabricating metal housing assembly 90 having first noble metal electrode 24 and second noble metal electrode 26. Referring to FIG. 9A, metal housing precursor 92 having the form illustrated in FIG. 7 may be formed by any of a number of known fabrication methods, including, for example, machining the metal housing precursor 92 from metal bar stock, such as steel bar stock, or extruding the general outer shape followed by machining of threads 20 and other features not formed during extrusion of the general form. Referring to FIG. 9B, a first housing end 98 of first noble metal ground electrode 24 is placed adjacent to annular electrode end 22 oriented with a first predetermined orientation necessary to obtain the configuration of first ground electrode 24 described herein and illustrated in FIGS. 2 and 4. Once first noble metal ground electrode 24 is oriented with respect to annular end 22 of metal housing 14, then a means for making a metallurgical bond 100 is introduced to apply energy sufficient to form a metallurgical bond between first noble metal ground electrode 24 and metal housing 14. Means for making the metallurgical bond 100 may be any known apparatus and method for making metallurgical bond 28, but will preferably comprise welding of these components such that metallurgical bond 28 comprises a weld joint. Welding may be performed by any welding method that is capable of forming metallurgical bond 28, including resistance welding and laser welding. FIG. 9B generally illustrates the application of resistance welding by application of a welding electrode 102. Given the relatively high melting point of the noble metals, particularly iridium and many iridium alloys, welding will typically comprise localized melting and reflow of the metal housing at and adjacent to the interface with first noble metal ground electrode 24, such that the electrode 24 is sufficiently wet by and bonded to the housing. The extent of interdiffusion of the electrode and metal housing and the constituents and microstructure of the heat affected zone and metallurgical bond 28 will depend upon the noble metal selected for ground electrode 24 and the metal selected for metal housing 14. FIG. 9C illustrates the application of welding current and pressure through welding electrode 102 and the formation of metallurgical bond 28. FIG. 9C also illustrates that it may optionally be desirable to orient first noble metal electrode 24 following welding, such as by bending it downwardly as illustrated in phantom in this figure. It may also be desirable to adjust the final spark gap distance between first noble metal ground electrode 24 and center electrode 40 once insulator assembly 80 and metal housing assembly 90 have been assembled as described herein. Second noble metal ground electrode 26 using the same method as described for first ground electrode 24, except that it is located with a second predetermined orientation with respect to the annular end 22 of metal housing 14 which will necessarily be different from first predetermined orientation of the first noble metal electrode 24, as illustrated in FIGS. 2 and 4. It is preferred that first noble metal ground electrode 24 and second metal ground electrode be oriented in the generally opposed and offset configuration, such as shown in FIGS. 2 and 4. However, it is believed that other configurations where these electrodes are oriented in a generally perpendicular configuration and form first spark gap 74 and second spark gap 76 with adjacent first side face 62 and second side face 64 of firing tip 50 may also be possible. First and second noble metal electrodes 24, 26 may be placed in any desired configuration so long as the configuration does not interfere with production of sparks at spark gaps 74, 76 during operation of spark plug 12.

The invention may be further understood with reference to the following example. A metal housing precursor of standard industrial spark plug dimensions was fabricated from low carbon steel (AISI 1018). Two identical noble metal alloy ground electrodes 24, 26 were formed from an iridium alloy consisting of, by weight, 2.0% Rh, 0.3% W, 0.02% Zr and the balance Ir and impurities. The electrodes 24, 26 each had a square cross-sectional shape, 0.030 inches on a side, and a length of 0.244 inches. The electrodes were resistance welded to the annular lower surface 22 of the metal housing precursor to form the metal housing assembly.

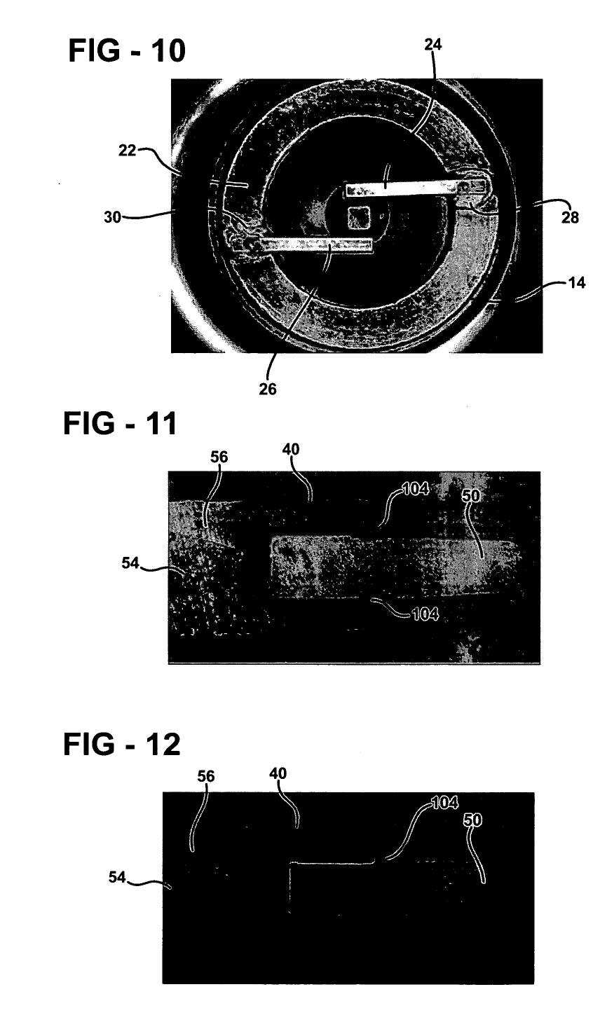

The center electrode 40 was formed with a generally cylindrical base formed with a Ni-alloy shell and a Cu alloy core. The Ni alloy consisted of, by weight, 1.65% Cr, 0.35% Si, 1.80% Mn, 0.20% Ti, 0.10% Zr and the balance Ni and impurities. The Cu alloy consisted of pure Cu except for impurities. The base had a diameter of 0.130 inches and had an axial cylindrical bore formed in an end face having a diameter of 0.051 inches and a depth of 0.100 inches. A noble metal firing tip formed of the same Ir alloy as the ground electrodes and having a square cross-sectional shape, 0.040 inches on a side, and a length of 0.185 inches was inserted into the axial bore. The firing tip was then laser welded around the perimeter at the interface of the end face of the base and the firing tip to form metallurgical bond 60. Known procedures for cleaning and degreasing components were applied prior to welding. An optical photomicrograph of a cross-section taken through the diagonal of the firing tip and end of the base is shown as FIG. 11. An optical photomicrograph of a cross-section taken approximately through the midpoint of a side face of firing tip is shown as FIG. 12. As may be seen, even though the square cross-section firing tip is inserted in circular axial bore, the localized reflow of these components in the heat affected zone 104 is sufficient to ensure wetting of the firing tip around its perimeter and the formation of a continuous metallurgical bond, in the form of a weld, around the perimeter of the firing tip. The center electrode with the bonded firing tip was then assembled into the insulator to form insulator assembly. The insulator assembly with the center electrode and Ir alloy firing tip and the metal housing assembly with the Ir alloy ground electrodes 24, 26 were then fixed to one another as described above. The resulting spark plug 106 having Ir fine wire ground electrodes 108 and Ir fine wire firing tip 110 are illustrated in a photograph as FIG. 10.

Obviously, many modifications and variations of the present invention are possible in light of the above teachings. It is, therefore, to be understood that within the scope of the appended claims, the invention may be practiced otherwise than as specifically described. The invention is defined by the claims.

What is claimed is:

1. An ignition device for an internal combustion engine, comprising:
a metal housing;
an insulator secured within said metal housing and having an exposed electrode end at an opening in said housing;
a center electrode having an electrode base mounted in said insulator and extending out of said insulator through the electrode end, the base portion having an axial bore in an end proximate the electrode end of said insulator and a noble metal firing tip comprising a rectangular cross-section and having a first side face and a second side face, which is located partly within the axial bore and a metallurgically bond between the firing tip and the base, the first side face and the second side face extending axially away from the end of the base;
a first noble metal ground electrode comprising a rectangular cross-section having a metallurgical bond on a first housing end to said metal housing and extending to a first firing end having a first firing end face that is adjacent to one of first side face and second side face such that a first spark gap exists therebetween; and
a second noble metal ground electrode comprising a rectangular cross-section having a metallurgical bond on a second housing end to said metal housing and extending to a second firing end having a second firing end face that is adjacent to the other of first side face and second side face such that a second spark gap exists therebetween.

2. The ignition device of claim 1, wherein said metal housing is made from steel.

3. The ignition device of claim 1, wherein the noble metals of the firing tip, first ground electrode and second ground electrode are selected from a group consisting of iridium, platinum, palladium, rhodium, gold, silver and osmium, and alloys thereof.

4. The ignition device of claim 3, wherein the noble metal also comprises a metal from the group consisting of tungsten, yttrium, lanthanum, ruthenium and zirconium as an alloying addition.

5. The ignition device of claim 1, wherein the rectangular cross-section of at least one of said first noble metal ground electrode and said second noble metal ground electrode is a square cross-section.

6. The ignition device of claim 1, wherein the rectangular cross-sections of both of said first noble metal ground electrode and said second noble metal ground electrode are square cross-sections.

7. The ignition device of claim 1, wherein the rectangular cross-section of the noble metal firing tip of the center electrode is a square cross-section.

8. The ignition device of claim 7, wherein the rectangular cross-section of the noble metal firing tip of the center electrode is a square cross-section.

9. The ignition device of claim 1, wherein the base of the center electrode comprises a Ni alloy shell at least partially enclosing a Cu alloy core proximate the end of the base, and wherein the axial bore is formed within the Ni alloy shell.

10. The ignition device of claim 1, wherein the base of the center electrode comprises a Ni alloy shell at least partially enclosing a Cu alloy core proximate the end of the base, and wherein the axial bore extends through the Ni alloy shell to the Cu alloy core such that the noble metal firing tip is in touching contact with the Cu alloy core.

11. The ignition device of claim 1, wherein the metallurgical bonds between the first noble metal electrode and the second noble metal electrode comprise resistance welds.

12. The ignition device of claim 1, wherein the first firing end face is substantially parallel to one of the first side face and the second side face and the second firing end face is substantially parallel to the other of the first side face and the second side face.

13. The ignition device of claim 1, wherein said insulator has a terminal end extending axially from a terminal opening in the metal housing, and wherein the distance from the terminal end of said insulator to the terminal opening of said metal housing is greater than 1 inch.

14. An ignition device for an internal combustion engine, comprising:
a steel housing having an electrode bonding surface;
an insulator secured within said metal housing and having an exposed electrode end at an opening in said housing;
a center electrode having an electrode base mounted in said insulator and extending out of said insulator through the electrode end, the base portion having an axial bore in an end proximate the electrode end of said insulator and a noble metal firing tip comprising a rectangular cross-section and having a first side face and a second side face, which is located partly within the axial bore and a metallurgically bond between the firing tip and the base, the first side face and the second side face extending axially away from the end of the base;
a first Ir alloy ground electrode comprising a rectangular cross-section having a metallurgical bond on a first housing end to the electrode bonding surface and extending to a first firing end having a first firing end face that is adjacent to one of first side face and second side face such that a first spark gap exists therebetween; and
a second Ir alloy ground electrode comprising a rectangular cross-section having a metallurgical bond on a second housing end to the electrode bonding surface and extending to a second firing end having a second firing end face that is adjacent to the other of first side face and second side face such that a second spark gap exists therebetween.

15. The ignition device of claim 14, wherein the Ir alloys each comprise an alloy constituent from the group consisting of tungsten, yttrium, lanthanum, ruthenium and zirconium.

16. The ignition device of claim 14, wherein the rectangular cross-section of at least one of said first noble metal ground electrode and said second noble metal ground electrode is a square cross-section.

17. The ignition device of claim 14, wherein the rectangular cross-sections of both of said first noble metal ground electrode and said second noble metal ground electrode are square cross-sections.

18. The ignition device of claim 14, wherein the rectangular cross-section of the noble metal firing tip of the center electrode is a square cross-section.

19. The ignition device of claim 18, wherein the rectangular cross-section of the noble metal firing tip of the center electrode is a square cross-section.

20. The ignition device of claim 14, wherein the base of the center electrode comprises a Ni alloy shell at least partially enclosing a Cu alloy core proximate the end of the base, and wherein the axial bore is formed within the Ni alloy shell.

21. The ignition device of claim 14, wherein the base of the center electrode comprises a Ni alloy shell at least partially enclosing a Cu alloy core proximate the end of the base, and wherein the axial bore extends through the Ni alloy shell to the Cu alloy core such that the noble metal firing tip is in touching contact with the Cu alloy core.

22. The ignition device of claim 14, wherein the metallurgical bonds between the first noble metal electrode and the second noble metal electrode comprise resistance welds.

23. The ignition device of claim 14, wherein the Ir alloys each comprise an alloy constituent from the group consisting of platinum, palladium, rhodium, gold, silver and osmium.

24. The ignition device of claim 15, wherein the Ir alloys each comprise an alloy constituent from the group consisting of platinum, palladium, rhodium, gold, silver and osmium.

25. The ignition device of claim 14, wherein the first firing end face is substantially parallel to one of the first side face and the second side face and the second firing end face is substantially parallel to the other of the first side face and the second side face.

26. The ignition device of claim 14, wherein said insulator has a terminal end extending axially from a terminal opening in the steel housing, and wherein the distance from the terminal end of said insulator to the terminal opening of said steel housing is greater than 1 inch.
